(19) United States
(12) Patent Application Publication
(10) Pub. No.: US 2004/0184909 A1
(43) Pub. Date: Sep. 23, 2004

(54) Multi-rotor blade stackable vertical axis windmill

(76) Inventor: Lewis H. Miller, Chandler, OK (US)

Correspondence Address: MARTIN S. HIGH, P.O. BOX 217, STILLWATER, OK, 74076, US

(21) Appl. No.: 10/799,333

(22) Filed: Mar. 12, 2004

Related U.S. Application Data
(63) Continuation-in-part of application No. 10/064,180, filed on Jun. 19, 2002.
(60) Provisional application No. 60/299,383, filed on Jun. 19, 2001.

(51) Int. Cl. F03D 7/00

(52) U.S. Cl. 415/4.2

(57) ABSTRACT

A stackable, vertical axis windmill comprised of a braced external frame that enables stacking of multiple windmill assemblies. Couplings are located on both ends of the vertical rotor shaft to enable stacking and the transmission of power, an internal wind flow cavity, and controlled wind guides is described. The external frame includes structural bracing that allows for two or more windmill to be stacked one upon another to optimize the use of land or rooftop space for the generation of electricity from wind power. The internal wind flow cavity allows wind to transfer power to both the windward and leeward rotors blades. The rotor axis is constructed so that all bearings can be replaced without dismantling the structure

### CROSS-REFERENCE TO RELATED APPLICATIONS

This application is a continuation-in-part of co-pending U.S. patent application Ser. No. 10/064,180, filed on Jun. 19, 2002, entitled Stackable Vertical Axis Windmill, which in turn claims the benefit of U.S. Provisional Application No. 60/299,383, filed on Jun. 19, 2001. Both U.S. patent application Ser. No. 10/064,180 and U.S. Provisional Patent Application No. 60/299,383 are incorporated by reference in their entirety for all purposes as if fully set forth herein.

### STATEMENT REGARDING FEDERALLY SPONSORED RESEARCH OR DEVELOPMENT

Not applicable

### BACKGROUND OF THE INVENTION

a. Field of the Invention

The field of the instant invention is the generation of power using the motion of atmospheric wind. More specifically, the instant application teaches how to generate power from wind using a stackable, vertical axis windmill comprised of a braced external frame, rotors, bracing between rotor sections to increase the structural integrity of the complete multi-unit structure, an internal wind flow cavity, and wind guides to increase the efficiency.

b. Description of the Prior Art

As one would expect, the art in the area of windmills is plentiful. In the discussion that follows, the advantages and improvements of the various teachings of the prior art are summarized. Windmill design has progressed for hundreds of years. Various shapes and orientations have been studied including those with horizontal and vertical axis. Two basic types of windmill blades have been invented: drag-type blades and aerodynamic-type blades. The drag-type blades rely on the drag of the moving wind over the blades for transferring the kinetic energy from the wind to the blade, whereas the aerodynamic-type blades take advantage of the wind-foil shape of the blade to provide motion. Both types of blades have advantages and disadvantages that have been discussed in the literature.

A representative example of the art is U.S. Pat. No. 4,115,027 ('027) by Thomas that teaches a vertical windmill with airfoils mounted around a vertical axis. The support frame allows the airfoils to rotate around the central axis thereby generating the torque required to power an electrical generator. Attached to the support frame are stators that direct the wind to the airfoil blades. The unit is self-supported, but '027 does not teach how to expand the power production from this single unit.

Ewers in U.S. Pat. No. 4,134,707 ('707) teaches a vertical axis windmill with a segmented design that can be incrementally added to increase the power production of the overall unit. Patent '707 uses a vertically rising exoskeleton with four external standards and at least two vertically spaced sets of radially converging ribs. The rotor in '707 is saw-toothed shaped to capture the movement of the wind. Although not claimed in '707, the specification teaches that the exoskeleton is to be braced with external guide wires. External guide wires are troublesome when attempting to implement the wind power unit in confined areas or where the added land requirements make the guide wires unworkable or unsightly.

U.S. Pat. No. 5,910,688 by Li teaches an improvement to the traditional farm windmill that is commonly seen in the countryside in the United States. More advanced technology is commonly found in the art as well, such as taught in U.S. Pat. No. 5,506,453 by McCombs. McCombs teaches a more modern version of the traditional farm windmill and includes a dual rotor, single support system. Both the Li and McCombs patent teach horizontal axis windmills. The term horizontal axis means that the wind causes a shaft to turn to transmit power, and the shaft is parallel with the wind, or horizontal to the ground. The most significant disadvantage with horizontal axis windmills is that they are very difficult to scale, that is, to increase generation capacity easily. To increase the energy producing power of horizontal windmills additional windmills must be added adjacent to the location of the existing windmills that will increase the amount of land used thereby increasing the cost.

An alternative to the technology taught by Li and McCombs is the vertical axis windmill. U.S. Pat. No. 4,776,762 by Blowers is a representative technology for vertical axis windmills. Blowers teaches a power conversion turbine with a plurality of moveable blades. These blades open and close as the turbine rotates around its axis so as to make the best use of the wind. A single axis supports the turbine. In the configuration taught by Blowers, the turbine could be oriented so that the axis of rotation is vertical. In this way, the Blowers technology is scaleable by stacking several turbines vertically on the same axis.

Previous art that relates most closely to the instant invention is U.S. Pat. No. 6,242,818 ('818) by Smedley. Smedley teaches a vertical axis wind turbine having a plurality of blades around a vertical axis. The blades contain a wind catching surface and doors that open or close depending on the speed of the wind. The doors are inclined and are mounted on a pivot axis. As the windmill rotates at a higher velocity, the doors are forced outward thereby reducing the wind catching capability of the wind catching surface. In this manner, the '818 device is self-regulating. As the wind velocity increases past a critical velocity, the doors close to govern the rotational velocity of the windmill. Blowers also teaches the scalability of the device by stacking turbines vertically on the axis. The vertical axis is the only structural support of the device taught by Blowers.

The previous art suffers from several drawbacks. First, windmills that rely on horizontal axis turbines require additional land for scalability and additional machinery for transmitting the power from a horizontal axis to the ground for electricity generation. Second, the vertical axis windmills that rely on the rotor axis for structural support are not strong enough for the high velocity or gusty wind conditions common in many parts of the world. The instant invention addresses all of the disadvantages of the prior art by using a vertical shaft for transmission of power and an external frame to support the windmill.

The external frame is particularly important since this allows for the increased structural support of the windmill when two or more windmills are stacked. Stacking allows for more efficient use of costly land or rooftops. The external frame increases the overall strength of the windmill in contrast to the single member support, the power axis, used in prior devices.

### BRIEF SUMMARY OF THE INVENTION

It is therefore an object of the present invention to provide a device for the generation of power using the motion of atmospheric wind. More particularly, it is an object of the present invention to generate power from wind using a stackable, vertical axis windmill comprised of a braced external frame, rotors, bracing between and with a stackable sections to increase the structural integrity of the complete multi-unit structure, an internal wind flow cavity, and wind guides to increase the efficiency.

### BRIEF DESCRIPTION OF THE SEVERAL VIEWS OF THE DRAWING

FIG. 1 shows the overall shape and framing of the Two-Rotor Stackable Vertical Axis Windmill.

FIG. 2. shows a top view of the Two-Rotor Stackable Vertical Axis Windmill showing the bottom flange assembly of the rotor assembly that would be located above a given first rotor assembly.

FIG. 3 shows the structure of the outside vertical supports showing relative placement of wind guides

FIG. 4 shows the structure of the open frames.

FIG. 5 is a top view of the rotor assembly.

FIG. 6 is a side view of the rotor assembly showing one embodiment where the rotor panels are solid and a second embodiment where the rotor panels have openings formed by the rotor panels.

FIG. 7 shows the bottom flange, flex coupling, and top flange.

FIG. 8 shows a top view of a bottom flange.

### DETAILED DESCRIPTION OF THE INVENTION

a. Description

The instant invention, the two-rotor stackable vertical axis windmill, is comprised of a frame structure 10, rotor assembly 20, a plurality of outer wind guides 31, and a plurality of inner wind guides 36. Multiple instances of the instant invention can be stacked one upon the other to form a composite structure of up to 500 feet to harness the power of the moving wind. The description of the instant invention to follow will first focus on one instance of the invention and then later describe how multiple instances can be combined to form a larger structure capable of generating additional power.

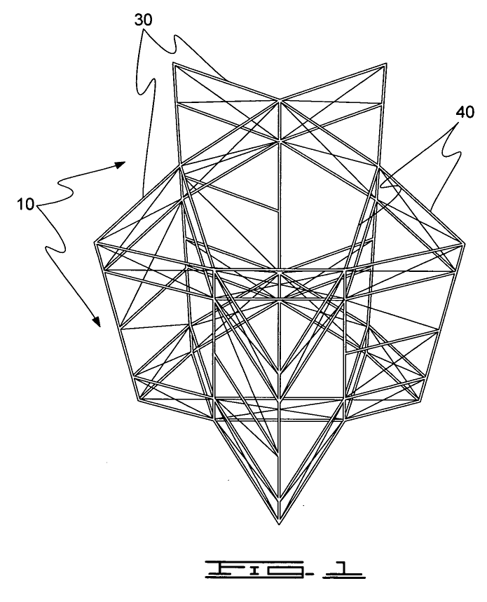

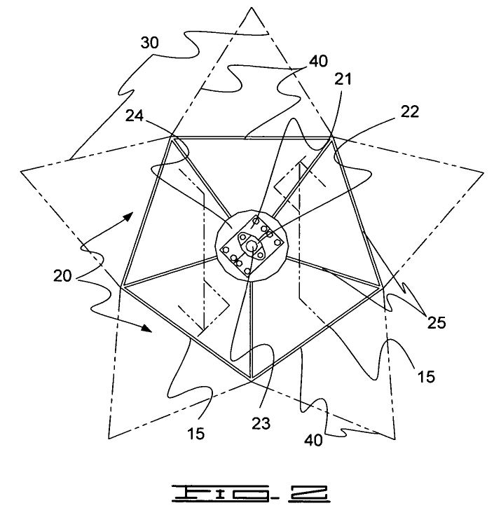

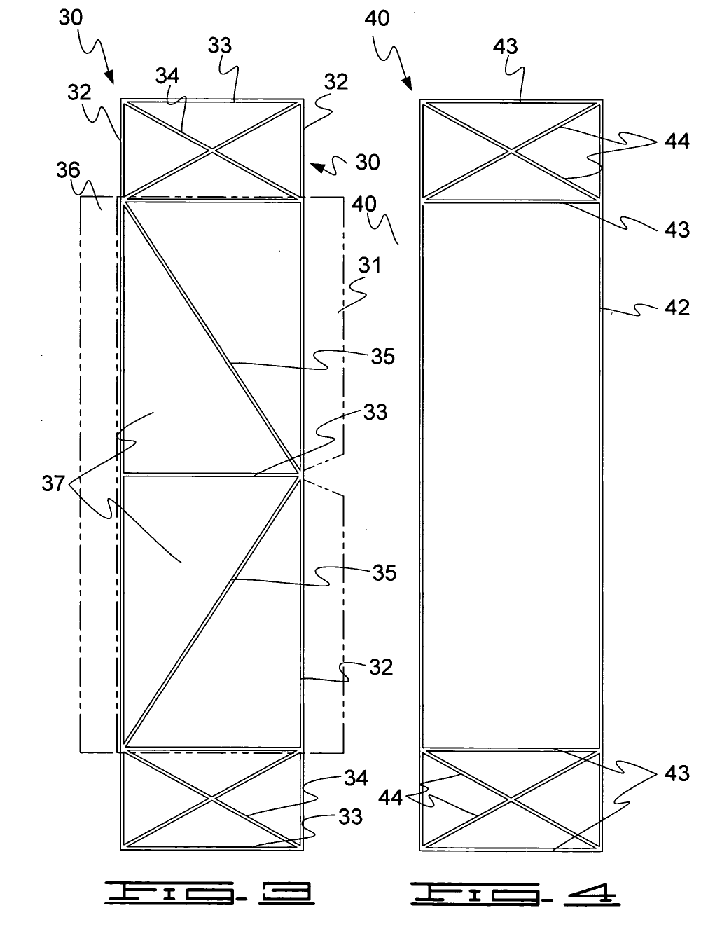

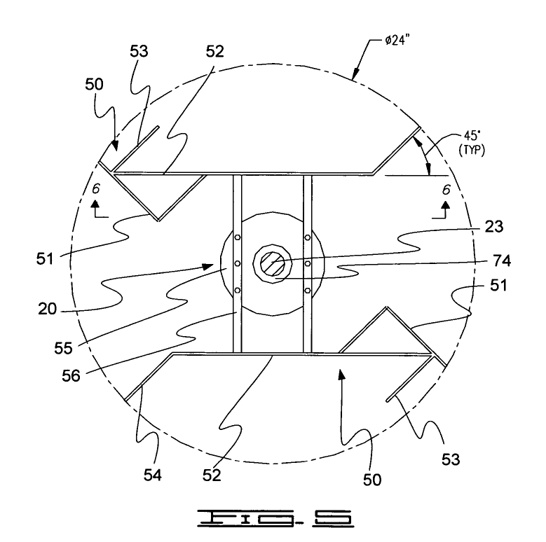

The frame structure 10 as illustrated in FIG. 1 is comprised of a plurality of solid frames 30 and a plurality of open frames 40. The solid frames 30, as shown in FIG. 3, are comprised of a plurality of solid frame vertical members 32, a plurality of solid frame horizontal members 33, a plurality of solid frame cross members 34, and a plurality of solid frame extended cross members 35. The solid frames 30 are also comprised of the outer wind guides 31 and the inner wind guides 36. The solid frames 30 support a wind guide panel 37 that serves to channel the wind inward to the rotor assembly 20.

The open frames 40 are comprised of a plurality of open frame vertical members 42, a plurality of open frame horizontal members 43, and a plurality of open frame cross members 44.

The solid frames 30 and the open frames 40 can be fabricated from wood, aluminum, composite materials, but most commonly are fabricated from steel. Connections used to fabricate the solid frames 30 and the open frames 40 are either threaded or welded connections. In one embodiment of the instant invention, five solid frames and ten open frames are connected to each other to form an essentially star shaped support structure with five apexes (shown in FIG. 1). In another embodiment, more solid frames and open frames can be connected to form structures with more than five apexes. In yet another embodiment, four open frames can be oriented to form a square structure, and four solid frames can project at various angles from the corners of the square to direct the air toward the rotor assembly. In an additional embodiment, three open frames can be oriented to form a triangle structure, and three solid frames can project at various angles from the corners of the triangle to direct the air toward the rotor assembly.

The rotor assembly 20 is comprised of a plurality of horizontal rotor assembly supports 25, a rotor axis 23, rotor panel assembly supports 56, a bottom flange assembly 70, a flex coupling assembly 72, and a top flange assembly 71. The horizontal rotor assembly supports 25 radiate outward from the top and bottom flange assemblies and connect the rotor assembly to the solid and inside frames. A plurality of open frame members 40 form the periphery of the rotor assembly 20. Further comprising the rotor assembly is the rotor axis 23 that is rotatably mounted inside the frame flange. The rotor assembly 20 is located within the frame structure comprised of the open frame 40 and solid frame 30 described above. More precisely, the rotor assembly 50 is axisymmetrically located within the frame structure with the rotor axis 23 aligned with the center of the frame structure. The rotor assembly can be further supported through the use of rotor support cables which are connected to various points on the rotor panels and rotor panel assembly supports. In a typical embodiment, rotor support cables are placed between opposite corners of the rotor panels and the rotor panel assembly supports.

The solid and open frames are further supported and stabilized with frame support cables. These frame support cables provide vertical and horizontal support and are typically placed from corner-to-corner forming x-bracing on the solid and open frames. In addition, guide wires are placed between the bottom corners of the rotor assembly 50 and the top flange assembly 71. Outside support cables are placed circumferentially on the outside perimeter of the entire structure. All support cables are of sufficient diameter to provided the necessary support, but are not a significant impediment to the wind entering or leaving the structure.

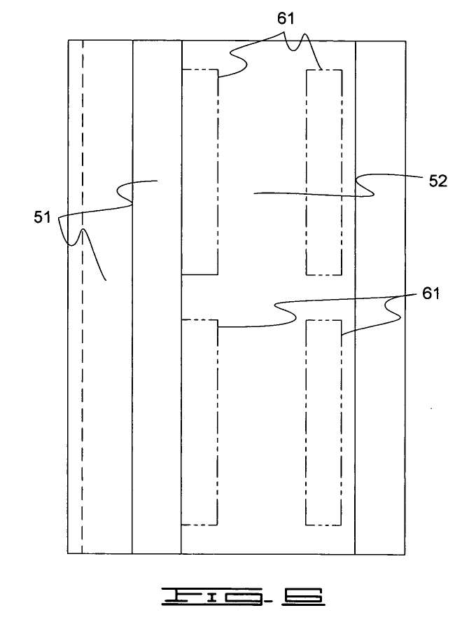

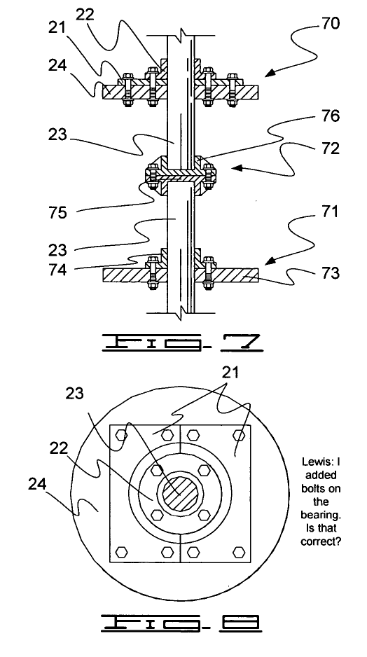

Further comprising the rotor assembly is two or more rotors panel assemblies 50. In one preferred embodiment of the instant invention, as shown in FIG. 5, the rotor assembly is comprised of two rotors panel assemblies 50. The rotors panel assemblies 50 are, in turn, comprised of a rotor panel 52, a trailing edge 53, a leading edge 54, and a windfoil 51. The rotor panel 52 is of rectangular shape of thin material typically aluminum, steel or wood. In one embodiment of the instant invention, the rotor panel 52 is formed of solid material with no openings to allow wind to pass. In another embodiment, in particularly windy climates, the rotor panels 52 can form rotor panel windows 61 to allow some of the wind to pass directly through the rotor assembly 50. The trailing edge 53, a leading edge 54, and a windfoil 51 are elongated structures affixed to the rotor panel 52 parallel with the rotor axis and are typically aluminum, steel or wood. A plurality of rotor flange supports 56 connect the rotor panels assemblies 50 to a plurality of rotor plates 55 so that as the wind exerts forces on the rotor panel assemblies 50, the plurality of rotor supports 55 turn the rotor axis 23 thereby transmitting the power.

The wind foil 51 is an elongated triangular structure running along the edge of the trailing edge parallel to the rotor axis 23. The leading edge 54 is affixed to the rotor panel 52 on the opposite side of the rotor panel 52 from the wind foil 51. The leading edge 54 is a thin rectangular sheet of material connected to the leading edge and oriented such that an angle of approximately 135 degrees is formed between the leading edge and the rotor panel 52. In another embodiment, the leading edge 54 is integrally formed from a single sheet of aluminum or steel with the rotor panel 52, but forms a structure with approximately 135 degrees between the main plane of the rotor panel 52 and the leading edge. The leading edge 54 is as long as the rotor panel 52, but between one-half and one-eighth as wide as the main blade body.

The trailing edge 53 is a thin rectangular sheet of material with essentially the same dimensions as found on the leading edge 54. The trailing edge 53 is connected to the rotor panel 52 and is oriented such that an angle of approximately 45 degrees is formed between the trailing edge 53 and the rotor panel 52. The orientation of the thin rectangular sheet of material connected to the leading edge is such that the thin rectangular sheet is orientated toward the main blade body. In another embodiment, the trailing edge 53 is integrally formed from a single sheet of aluminum or steel with the rotor panel 52 and the leading edge 54. But when the trailing edge 53 is formed from a single sheet of material, the trailing edge forms an angle of approximately 45 degrees with the main blade body. FIG. 5 illustrates a common embodiment showing a top view of the elongated triangular structure, thin rectangular sheet of material connected to the trailing edge, and the thin rectangular sheet of material connected to the leading edge.

In the rotor assembly 20, the plurality of rotor blades assemblies 50 are attached via threaded or welded connections to the plurality of horizontal rotor supports 56. The plurality of horizontal rotor supports 56 are rigidly attached to a plurality of rotor plates 55 by a welded connection or threaded connectors. The rotor plates 55 are affixed to the rotor axis by welded or threaded connections or in concert with a key to prevent the independent rotation of the rotor panels 52, rotor supports 55, rotor plates 55, and the rotor axis 23. In one common embodiment of the invention there are three rotor plates, a top, middle and bottom rotor plate. In this same embodiment, there are two parallel horizontal rotor supports 56 at approximately the top, middle and bottom portion of the rotor panel assemblies 50, connecting the rotor blade assemblies 50 to a top, middle and bottom rotor plates 55. In another embodiment of the instant invention, additional rotor plates may be added to the rotor assembly to increase the resistance to wind as it flows through the rotor assembly (see FIG. 9). As many as four additional rotor plates may be added.

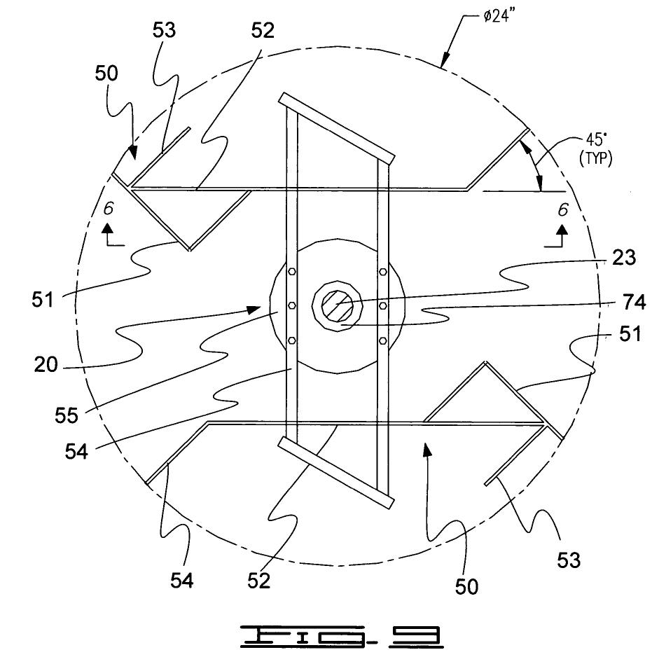

The bottom flange assembly 70, top frame flange assembly 71 along with the flexible coupling 72 is shown in more detail in FIG. 7 and is shown how two rotor assemblies can be combined. The rotor axis 23 of a given rotor assembly passes through a top frame flange assembly 71.

The top frame flange 71 assembly is comprised of a top flange plate 73 which is attached via a plurality of bolts to a top flange bearing 74. The rotor axis is terminated with a top coupling 75 which is attached via a weld to the top of the rotor axis 23. A corresponding rotor axis for the rotor assembly to be installed on top of the first rotor assembly is terminated on the bottom with a bottom coupling 76 which is attached via a weld to the bottom of the rotor axis 23. Two rotor assemblies are connected by attaching the top of one rotor axis with the bottom of another rotor axis and securing the connection with a plurality of coupling bolts. To prevent the two rotor assembly from rotating independently, the top coupling 75 and bottom coupling 76 are fitted with a key to force the top coupling 75 and bottom coupling 76 to rotate with the rotor axis 23 at the same rotational speed. The top coupling 75 and bottom coupling 76 that are placed between each rotor assembly provide some flexibility so that each rotor assembly can move independently to a small degree.

As is shown in FIG. 8, the bottom frame flange assembly 70 is comprised of a bottom flange plate 24, a split plate 21, and a bottom flange bearing 22. The bottom flange plate 24 is connected to the split plate via a plurality of bolts. The bottom flange bearing 22 is connected to the split plate and the bottom flange via a plurality of bolts. The split plate 21 allows for removal of the bottom flange bearing 22 without disassembly of multiple rotor assemblies. To replace a bottom flange bearing 22, all the bolts are first removed. Then the bolts in the flex coupling assembly 72 are removed and the bottom coupling 76 and key are removed. Both portions of the split plate 21 can be then removed. Lastly, the bottom flange bearing 22 then can pass through the opening in the bottom flange and off the bottom end of the rotor axis. A new bottom bearing can then be installed by reversing the procedure outlined above. The ability to replace the bottom bearing without complete disassembly of the entire stack of windmill assemblies is a unique and attractive feature of the instant invention.

The top bearing can also be removed using a similar procedure. The coupling bolts are removed along with the top coupling and key. Removing the top bearing bolts allows the top bearing.

When stacking additional entire assemblies of windmill one upon the other, the plurality of inside vertical members and inside vertical members can be connected via vertical support connectors to provide the necessary support for the entire structure. These connections are accomplished through bolted vertical support connectors so that windmill assemblies can be added or removed as necessary. If required, external guy wires can be employed to further steady the structure. Structures up to 500 feet can be created by stacking multiple windmill assemblies. A frame braced with internal cables only is capable of supporting a structure of up to 100 feet in height, but can be further supported by guide wires anchored to the ground.

In one embodiment to further support the structure when multiple windmill assemblies are stacked, interstitial cross braces, interstitial horizontal braces, and interstitial vertical braces are used to add support. Further a lace-up cable can be alternated between the outer vertical poles. Tension adjustment of the lace-up cable is provided at the base of the entire windmill structure.

b. Operation of the Invention

In the operation of the windmill, the wind passes across the air catching surface of the plurality of rotor blades and causes the rotors assembly to turn. The wind is caught by the leading edge 54 of the rotor blade assembly causing the rotor blade assembly to turn. In addition, as the wind as it passes over the wind foil 51 the wind also causes the rotor assembly to turn. A major advantage of this design is that even as wind is exiting the structure, the wind aids in turning the rotor.

The rotor axis 23 in the rotor assembly 20 is then connected to an electrical generator that uses the rotational energy of the rotor axis to produce electrical power. The shape of the rotor blades and the inside rotor blades can vary depending on wind condition, but are most commonly triangular, rectangular or airfoil shaped. The rotors are angled so the wind passing over the rotor provides some lift in the vertical direction both as the wind enters and exits the rotor assembly.

The best mode of operation for the vertical axis stackable windmill is for a single rotor assembly to be housed inside the external frame that in turn supports the wind guide assembly. Two or more of the windmills may be stacked and connected with a rotor coupling shown in FIG. 7. Under normal conditions the wind enters one side of the instant invention and causes the rotor assembly to turn. Power is transmitted through the rotor shaft to an electric generator or other device that uses the power generated by the windmill.

What is claimed is:

1. A stackable, vertical axis windmill comprised of a frame structure and a rotor assembly.

2. The stackable, vertical axis windmill as described in claim 1 wherein
a. the frame structure is comprised of a plurality of solid frames, a plurality of open frames, a plurality of frame support cables, a plurality of outside support cables;
b. the rotor assembly is comprised of a plurality of horizontal rotor assembly supports, a rotor axis, rotor panel assembly supports, a bottom flange assembly, a flex coupling assembly, a top flange assembly, and a plurality of rotor support cables.

3. The stackable, vertical axis windmill as described in claim 2 wherein
a. the rotor assembly is comprised of two or more rotors panel assemblies;
b. the rotors panel assemblies are comprised of a rotor panel, a trailing edge, a leading edge, and a windfoil;
c. the trailing edge, the leading edge, and the windfoil are elongated structures affixed to the rotor panel parallel with the rotor axis.

4. The stackable, vertical axis windmill as described in claim 3 wherein
a. the wind foil is an elongated triangular structure running along the edge of the trailing edge parallel to the rotor axis;
b. the leading edge is affixed to the rotor panel on the opposite side of the rotor panel from the wind foil;
c. the leading edge is a thin rectangular sheet of material connected to the trailing edge and oriented such that an angle of less than 60 degrees is formed between the small rectangular sheet and the rotor;
d. the trailing edge is a thin rectangular sheet of material with essentially the same dimensions as the leading edge;
e. the trailing edge is connected to the rotor panel and is oriented such that an angle of approximately 45 degrees is formed between the trailing edge and the rotor panel;
f. the top frame flange assembly is comprised of a top flange plate that is attached via a plurality of bolts to a top flange bearing;
g. the bottom frame flange assembly is comprised of a bottom flange plate, a split plate, and a bottom flange bearing.
